(19) United States
(12) Patent Application Publication
(10) Pub. No.: US 2019/0247959 A1
(43) Pub. Date: Aug. 15, 2019

(54) Part Marking System And Method Of Marking Parts

(71) Applicant: Triton Automation Group, LLC, Port Huron, MI (US)

(72) Inventors: Scott Austin, Port Huron, MI (US); Philip Peloso, Port Huron, MI (US)

(21) Appl. No.: 15/897,422

(22) Filed: Feb. 15, 2018

(51) Int. Cl. B23K 26/362; B23K 26/08; B23K 31/12; B41M 5/24

(52) U.S. Cl. CPC B23K 26/362; B23K 26/0838; B41M 5/24; B23K 31/12; B23K 26/0884

(57) ABSTRACT

A part marking system comprising a part marking assembly having a marking conveyor, a position verification member and a marking structure. The marking conveyor includes a first end and a second end. The position verification member is associated with the marking conveyor and is structurally configured to determine the position of a part on the marking conveyor. The marking structure includes a robotic arm positioned in proximity to the marking conveyor, that has a laser marking member at a working end thereof. The laser marking member is structurally configured to laser etch indicia onto a part on the marking conveyor. The robotic arm is structurally configured to move the laser marking member to the proper orientation based on the position of the part, to, in turn, laser etch indicia onto a part while the part is on the marking conveyor and moving on the marking conveyor between the first end and the second end.

### CROSS-REFERENCE TO RELATED APPLICATION

N/A

### BACKGROUND OF THE DISCLOSURE

### 1. Field of the Disclosure

The disclosure relates in general to automation equipment, and more particularly, to a part marking system and a method of marking parts. It will be understood that for purposes of the disclosure, the terms part and component are used interchangeably, and it will be understood that when reference is made to either, what is meant is any part, component, subassembly, assembly, or structure that is to receive a laser etching, which may comprise a part number, assembly number, bar code, date/time stamp, a manufacturing location, symbol, drawing or other indicia.

### 2. Background Art

With increased automation and computer control of processes and assemblies, it has been increasingly desirable to imprint data onto, for example, a part. Whereas in the past, a part may only include a part number or the like, it has become desirable to provide additional information on the part, including, but not limited to, for example, an assembly number, a bar code, a date/time stamp, a manufacturing location, a symbol, a drawing, or other indicia.

In some installations and facilities, such information is preferably laser etched into the part. Generally, the part is placed manually, or through automation, into a fixture. Once placed into the fixture, a laser is activated to laser etch the information onto the part. Generally, the part is fixed, as is the laser.

Such a process does have drawbacks. For example, the process requires the placement of the part into a fixture to immobilize the part. Second, after the laser etching process, which takes a few seconds, the part is removed. The process is therefore quite labor intensive and also quite time consuming. Furthermore, the use of fixtures requires additional storage thereof, when not in use, as well as added costs.

### SUMMARY OF THE DISCLOSURE

The disclosure is directed in one aspect to a part marking system comprising a part marking assembly. The part marking assembly includes a marking conveyor, a position verification member, and a marking structure. The marking conveyor has a first end and a second end. The position verification member is associated with the marking conveyor. The position verification member is structurally configured to determine the position of a part on the marking conveyor. The marking structure comprises a robotic arm positioned in proximity to the marking conveyor. The robotic arm has a laser marking member at a working end thereof. The laser marking member is structurally configured to laser etch indicia onto a part on the marking conveyor. The robotic arm is structurally configured to move the laser marking member to the proper orientation based on the position of the part, to, in turn, laser etch indicia onto a part while the part is on the marking conveyor and moving on the marking conveyor between the first end and the second end.

In some configurations, the position verification member comprises a camera.

In some configurations, the robotic arm has six degrees of freedom.

In come configurations, the marking system further includes a part positioning assembly. The part positioning assembly comprises a positioning conveyor and a positioning assembly. The positioning conveyor has a first end and a second end. The second end meets the first end of the marking conveyor. The positioning assembly has a camera and a monitor. The camera is directed to the positioning conveyor. The monitor is structurally configured to display an image from the camera.

In some configurations, the positioning conveyor and the marking conveyor operate at different speeds.

In some configurations, the positioning conveyor and the marking conveyor are substantially coplanar.

In some configurations, the marking conveyor is sized so as to be capable of having a plurality of parts thereon simultaneously.

In some configurations, the part marking system further comprises a part sorting assembly and a part discharging assembly. The part sorting assembly comprises a discharge conveyor having a first end and a second end, with the first end meeting the second end of the marking conveyor. The part discharge assembly has at least one discharge location.

In some configurations, the part sorting assembly includes a pivot at the first end thereof. An adjustment member is coupled to the conveyor between the first end and the second end thereof, to, in turn, pivot the second end about the pivot.

In some configurations, the part discharge assembly has an upper part discharge location and a lower part discharge location. The second end of the discharge conveyor being pivotable so as to be selectively positionable to correspond to each one of the upper part discharge location and the lower part discharge location.

In some configurations, the part marking system further includes a part positioning assembly, the part positioning assembly comprises a positioning conveyor and a positioning assembly. The positioning conveyor has a first end and a second end. The second end meets the first end of the marking conveyor. The positioning assembly has a camera and a monitor. The camera is directed to the positioning conveyor. The monitor is structurally configured to display an image from the camera. Further, a part sorting assembly is provided and a part discharge assembly. The part sorting assembly comprises a discharge conveyor having a first end and a second end, with the first end meeting the second end of the marking conveyor. The part discharge assembly has at least one discharge location.

In another aspect of the disclosure, the disclosure is directed to a method of marking at least one product. The method comprises the steps of providing a part marking assembly, the part marking assembly, including of the type identified herein; placing a part on the marking conveyor; actuating the marking conveyor to move the part on the conveyor toward the second end thereof; actuating the robotic arm to position the laser marking member in a desired orientation to laser etch onto the part; activating laser marking member to laser etch onto the part while the marking conveyor is actuated.

In some configurations, the laser marking member is moving throughout the step of activating.

In some configurations, the method includes the steps of positioning the part on a positioning conveyor; and transferring the part from a positioning conveyor to the marking conveyor.

In some configurations, the step of positioning the part on a positioning conveyor further comprises the steps of: placing the part on the positioning conveyor; viewing a monitor coupled to a camera viewing the part, the monitor providing an indication as to the proper placement of the part on the positioning conveyor; selectively adjusting the position of the part in response to viewing the monitor and determining that the part is not in the proper placement; confirming that the part is in the proper placement; and releasing the part after confirming that the part is in the proper placement.

In some configurations, the monitor further provides an indication as to how to move the part in the event that the part is not in the proper placement.

In some configurations, the positioning conveyor is moving during the steps of viewing, selectively adjusting, confirming and releasing. In some such configurations, the positioning conveyor is moving during the step of placing.

In some configurations, the method further comprises the steps of: discharging the part from the marking conveyor; and receiving the part onto a discharge conveyor.

In some configurations, the laser marking member remains stationary during the step of activating the laser marking member while the laser is etching.

### BRIEF DESCRIPTION OF THE DRAWINGS

The disclosure will now be described with reference to the drawings wherein:

FIG. 1 of the drawings is a perspective view of the part marking system of the present disclosure;

FIG. 2 of the drawings is a side elevational view of the part marking system of the present disclosure;

FIG. 3 of the drawings is a top plan view of the part marking system of the present disclosure;

FIG. 4 of the drawings is a partial perspective view of the system, showing, in particular, the part positioning assembly of the present disclosure;

FIG. 5 of the drawings is a partial perspective view of the system, showing, in particular, the part marking assembly of the present disclosure;

FIG. 6 of the drawings is a partial perspective view of the system, showing, in particular, the part sorting and part discharge assemblies of the part marking assembly of the present disclosure;

FIG. 7 of the drawings is a front plan view of an image on the monitor display of the positioning subassembly of the part positioning assembly of the part marking assembly of the present disclosure, showing, in particular, a properly positioned and oriented part;

FIG. 8 of the drawings is a front plan view of an image on the monitor display of the positioning subassembly of the part positioning assembly of the part marking assembly of the present disclosure, showing, in particular, a properly positioned part that is improperly angularly oriented;

FIG. 9 of the drawings is a front plan view of an image on the monitor display of the positioning subassembly of the part positioning assembly of the part marking assembly of the present disclosure, showing, in particular, an improperly positioned and oriented part; and

FIG. 10 of the drawings is a schematic representation of a computing device with which the present invention can be utilized in a method of marking parts.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

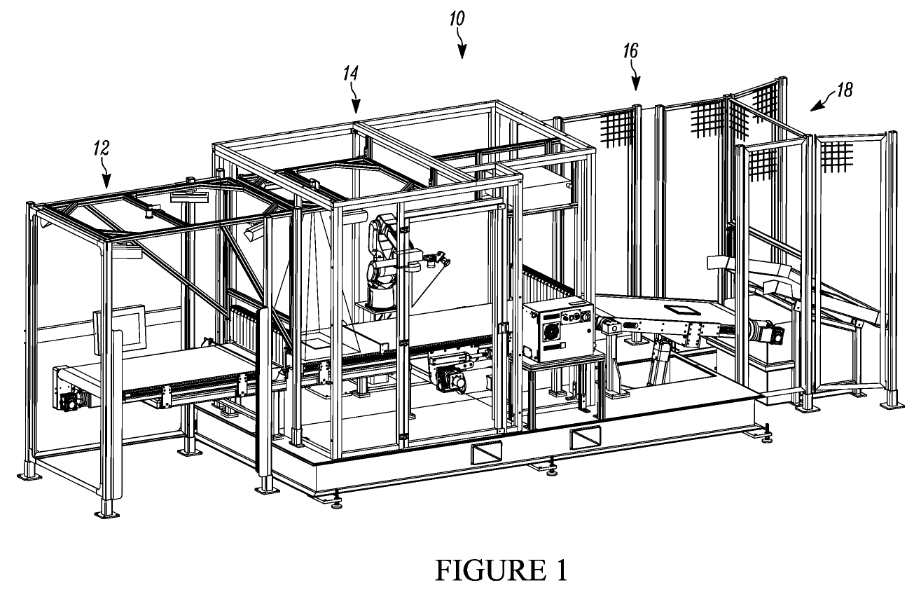

Referring now to the drawings and in particular to FIG. 1, the part marking system and method of marking parts is disclosed. The part marking system is shown generally at 10. The system is generally configured for use in a number of different environments for purposes of marking generally metal parts with identification numbers, such as bar codes, part numbers, and other properties. In the configuration shown, the marking is achieved through laser etching, but is not specifically limited thereto. Additionally, the particular types of parts, the materials from which the parts are made are not limited to any particular configuration or material; rather, the disclosure and identification should be deemed as exemplary. In the configuration shown, the system is generally utilized to mark metal automotive parts (while, again, not being limited thereto).

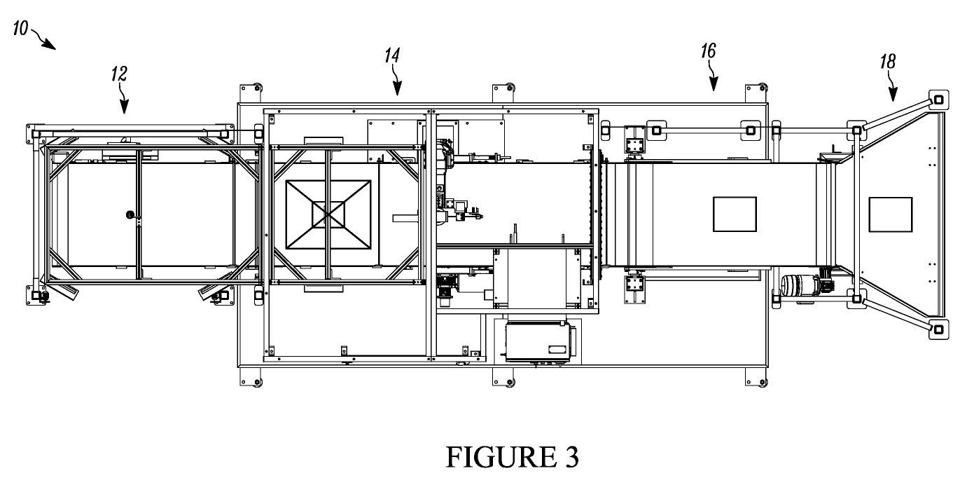

The system 10 is shown in FIGS. 1 through 3 as comprising part positioning assembly 12, part marking assembly 14, part sorting assembly 16 and part discharge assembly 18. It will be understood that the different assemblies may be coupled together and positioned sequentially so that a part can progress from the part positioning assembly at a first end to the part discharge assembly at the other end. It will be understood that the configuration of the individual assemblies can be varied within the scope of the present disclosure, without limitation. A plurality of parts 11 can be shown at various locations along the system in FIGS. 1 through 3.

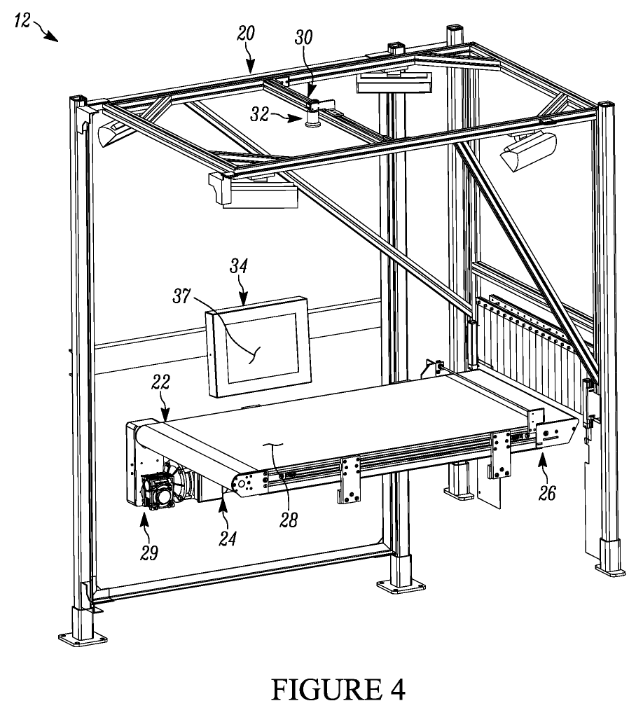

The part positioning assembly 12 is shown in greater detail in FIG. 4 as comprising frame 20, positioning conveyor 22 and positioning subassembly 30. The frame 20 comprises a plurality of beam structures that are coupled together to provide support for the different structures. It will be understood that a number of different frame constructions, configurations and materials are contemplated for use, and that the frame shown in FIG. 1 is merely exemplary.

The positioning conveyor 22 is shown in FIG. 1 as extending between first end 24 and second end 26. Additionally, the positioning conveyor 22 defines an upper surface 28. The upper surface is generally planar and substantially horizontal in configuration. In the configuration shown, the positioning conveyor is moved through an electric motor 29 whose speed can generally be tightly controlled and varied as desired.

The positioning subassembly is shown in FIG. 4 as comprising camera 32, monitor display 34 and computing device 36. The camera 32 is mounted to the frame so as to have its lens directed at the upper surface 28 of the positioning conveyor 22. In the configuration shown, the camera 32 is mounted directly above the conveyor, with the lens extending substantially perpendicular to the positioning conveyor. In other configurations, the camera may be oblique to the positioning conveyor.

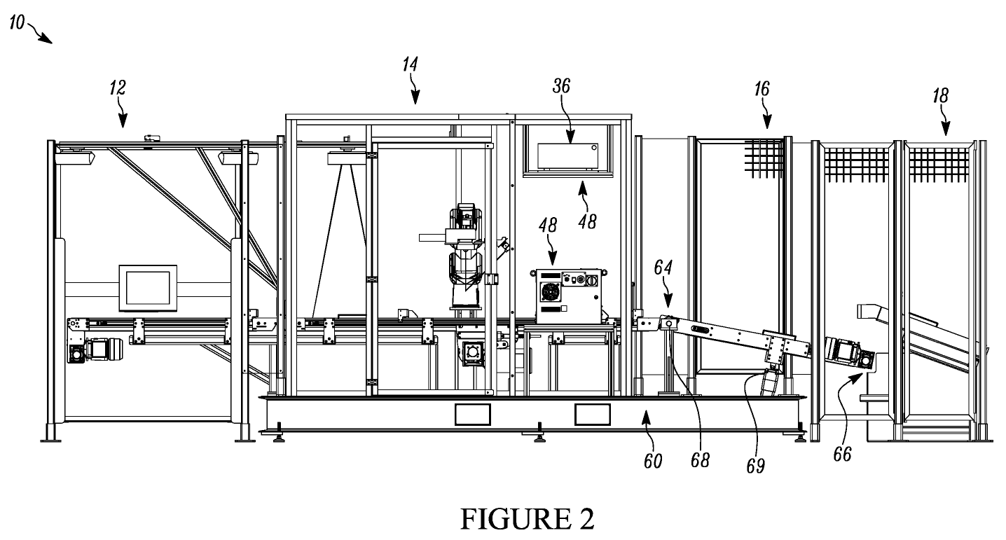

The monitor display 34 is positioned proximate the positioning conveyor 22 so that a user that is to manipulate parts or components on the positioning conveyor in view of the camera 32 can see the monitor display 34. The monitor display 34 is coupled, in the preferred configuration, to a computing device, such as computing device 100 (FIG. 2), as is the camera 32.

It will be understood that although not required, aspects of the descriptions below will be provided in the general context of computer-executable instructions, being executed by a computing device, namely computing device 100, along with other remote computing devices through outside communication where necessary, optional and/or desired. More specifically, aspects of the description below will reference acts, methods and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to a specialized industrial vision processing system (which may be highly proprietary), a conventional server computing racks or conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments linked through a communications network. In a distributed computing environment, program modules may be located in both local and remote memory storage devices.

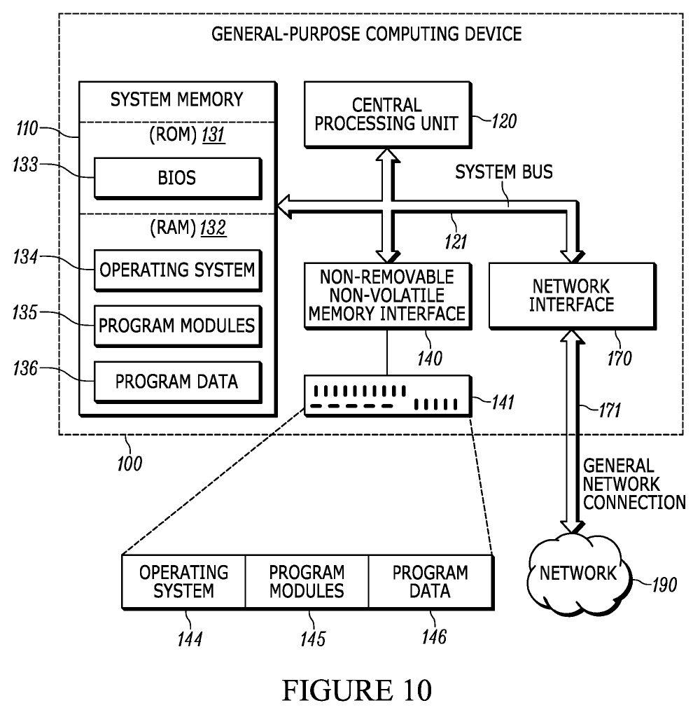

With reference to FIG. 10, an exemplary general-purpose computing device is illustrated in the form of the exemplary general-purpose computing device 100. The general-purpose computing device 100 will be described with the understanding that variations can be made thereto. The exemplary general-purpose computing device 100 can include, but is not limited to, one or more central processing units (CPUs) 120, a system memory 130 and a system bus 121 that couples various system components including the system memory to the processing unit 120. The system bus 121 may be any of several types of bus structures including a memory bus or memory controller, a peripheral bus, and a local bus using any of a variety of bus architectures. Depending on the specific physical implementation, one or more of the CPUs 120, the system memory 130 and other components of the general-purpose computing device 100 can be physically co-located, such as on a single chip. In such a case, some or all of the system bus 121 can be nothing more than communicational pathways within a single chip structure and its illustration in FIG. 10 can be nothing more than notational convenience for the purpose of illustration.

The general-purpose computing device 100 also typically includes computer readable media, which can include any available media that can be accessed by computing device 100. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 100. Computer storage media does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the general-purpose computing device 100 may operate in a networked environment via logical connections to one or more remote computers. The logical connection depicted in FIG. 1 is a general network connection 171 to the network 190, which can be a local area network (LAN), a wide area network (WAN) such as the Internet, or other networks. The computing device 100 is connected to the general network connection 171 through a network interface or adapter 170 that is, in turn, connected to the system bus 121. In a networked environment, program modules depicted relative to the general-purpose computing device 100, or portions or peripherals thereof, may be stored in the memory of one or more other computing devices that are communicatively coupled to the general-purpose computing device 100 through the general network connection 171. It will be appreciated that the network connections shown are exemplary and other means of establishing a communications link between computing devices may be used.

The general-purpose computing device 100 may also include other removable/non-removable, volatile/nonvolatile computer storage media. By way of example only, FIG. 10 illustrates a hard disk drive 141 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 10, provide storage of computer readable instructions, data structures, program modules and other data for the general-purpose computing device 100. In FIG. 10, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers here to illustrate that, at a minimum, they are different copies.

The operation of the computing device, and the display and interaction thereof with the monitor display 34 will be described in greater detail below in the description of the method associated with the disclosure.

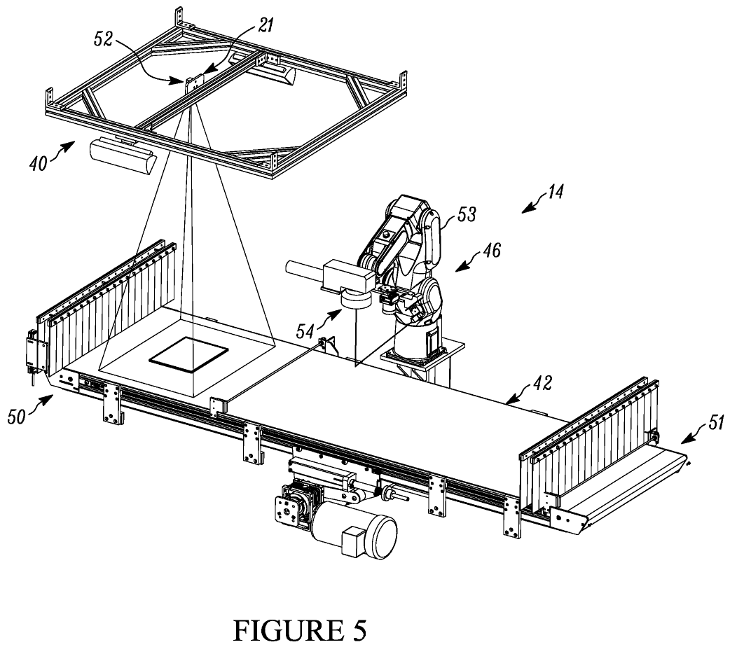

The part marking assembly is shown in FIG. 5 in greater detail as comprising frame 40, marking conveyor 42, position verification member 44, marking structure 46 and marking verification member 48. As with the frame 20, the frame 40 includes a plurality of beams and couplings to form a structure to which the components can be fastened directly or indirectly, or supported thereby. Additionally, the frame 40 can provide a support for housings and other protective structures which preclude and/or minimize injury to users.

The marking conveyor 42 includes a first end 50 and a second end 52. The first end 50 generally corresponds to the second end 26 of the positioning conveyor 22. The marking conveyor 42 further includes upper surface 52 which generally corresponds to upper surface 28 of the positioning conveyor 22. Motor 53 controls the speed and motion of the marking conveyor. It will be understood that the motor 53 may likewise be controlled by the computing device 100. In some configurations, the positioning conveyor 22 and the marking conveyor 42 may comprise a single conveyor with a single motor and upper surface. In other configurations, there may be additional conveyors positioned between the positioning conveyor and the marking conveyor.

It is contemplated that the upper surfaces of the conveyors may be co-planar, or may be varied depending on the particular configuration. In other configurations, the upper surfaces may be oblique to each other (regardless of how many actual separate conveyors are provided. In still further configurations, the conveyors may comprise other structures, that is, for example, and without limitation, other motive structures, that do not comprise belts, such as individually moving components or structures that can move parts between different locations or structures, and/or that can translate parts as desired.

The position verification member 44 comprises a camera 52 which is directed at the upper surface 52 of the marking conveyor 42 upstream of the marking structure. In the configuration shown, the camera 52 is coupled to the frame and has its lenses generally parallel to the upper surface of the marking conveyor. In other configurations, different orientations and positions are contemplated. In other configurations, other sensors or the like can be utilized in the place or in addition to the camera, such as position sensors, proximity sensors and the like.

The marking structure 46 comprises a robotic arm 55 and a laser marking member 56 mounted to a working end 59 of the robotic arm 55. In the configuration shown, the robotic arm comprises a Model LR Mate 200iD available from FANUC America located in Rochester Hills, Mich. The disclosure is not limited to such a robotic arm, or a robotic arm in particular, and other devices which provide sufficient axis of motion are likewise contemplated. Advantageously, the robotic arm 55 has sufficient degrees of freedom and has the response necessary to achieve throughput at a desired rate, in the configuration shown, six degrees of freedom. It will be understood that the robotic arm 55 is positioned proximate the upper surface of the marking conveyor so that the working end 59 can traverse at least a portion of the upper surface 52 thereof. The operation of the robotic arm will be described below in the operation and method in which the system operates.

The laser marking member 56 comprises a Model LMF70-HP available from Amada Miyachi located in Monrovia, Calif. The laser marking member, as will be explained below, is configured to laser etch into different materials, including, but not limited to, metals and the like. A number of different laser marking members are contemplated, as are other devices which can apply or imprint a part number in a contactless manner with the part or component to be marked. That is, the system is not limited to a laser or to the particular laser marking member disclosed and claimed herein. There are, in the configuration shown, multiple mirror galvanometers (often termed “galvos”) inside the laser marking head that cause the laser beam to move. As such, the laser marking member may remain stationary during laser etching, although through the galvos, the laser etching occurs over an area, and, all of which occurs during movement of the part on the conveyor.

The marking verification member 48 further comprises a camera 56 which is coupled to the frame. The camera can review and see parts after the application by the laser marking member (and the indicia disposed on the part).

In some configurations, it will be understood that the position verification member and the marking verification member can be omitted from certain designs. It will be understood that manual visual reviews and verifications can me made instead. In other configurations, it will be understood that other verification steps can be introduced, or, verification steps can be omitted entirely. It will also be understood that in various different configurations, multiple verification members may be presented at additional or between the stages at which the verification members are introduced in the disclosed configuration.

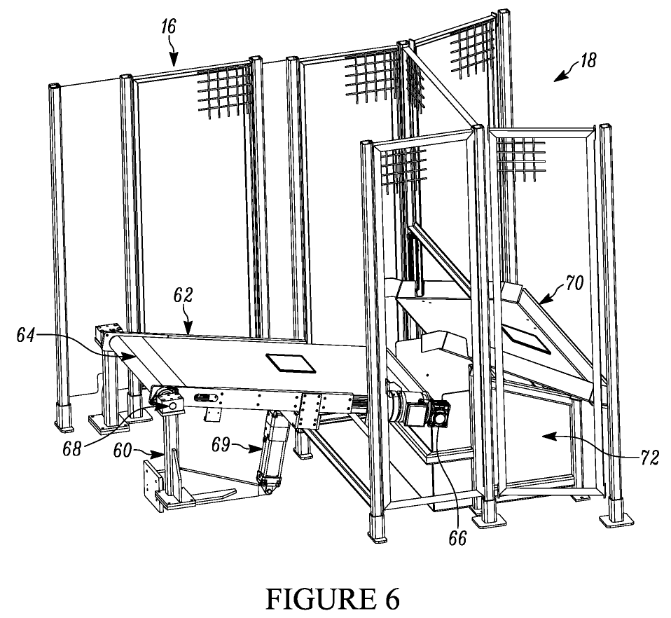

The part sorting assembly is shown in FIG. 6 as comprising frame 60 and discharge conveyor 62. The frame 60 is associated with the frame 40 and frame 20, preferably, and provides a basis upon which the components of the part sorting assembly can be mounted so as to support the different components. The discharge conveyor extends between first end 64 and second end 66, and includes upper surface 67. The conveyor is powered by motor 65. It will be understood that this conveyor can be combined with the positioning conveyor and/or the marking conveyor in some configurations. The upper surface 67 at first end 64 generally corresponds to the upper surface 52 of the marking conveyor at the second end 52 thereof. It will be understood that the two conveyors may operate at the same or at different speeds relative to each other.

In the configuration shown, the discharge conveyor 62 is configured to pivot so as to be able to alter the position of the second end thereof. In particular, the discharge conveyor 62 can pivot about pivot 68 which pivoting and position can be controlled by adjustment member 69. In the configuration shown, the adjustment member 69 comprises a pneumatic cylinder, which can be coupled to and controlled by the computing device 36. In the configuration shown, the discharge conveyor can be directed between two positions, a lower position and an upper position. It will be understood that in other configurations, the conveyor may be stationary, or may be movable, pivotable or translatable in different directions. It will further be understood that other means or members (such as arms, picking devices or the like) can be utilized to separate or discharge elements from the part sorting assembly. Additionally, in still other configurations, the discharge conveyor may be fixed instead of pivoting.

The part discharge assembly 18 is likewise shown in FIG. 6 as comprising upper part discharge location 70 and lower part discharge location 72. In the configuration shown, the upper part discharge location 70 comprises an inclined surface with a stop, wherein once a part is disposed by the discharge conveyor to the inclined surface, an operator can come and remove the part. Additionally, in the configuration shown, the lower part discharge location comprises a locked container. It is contemplated that parts that have been improperly marked or not marked at all can be directed into the locked container, by pivoting the discharge conveyor to the appropriate position to discharge into the lower part discharge location 72.

It will be understood that in other configurations, the discharge assembly 18 may comprise additional conveyors that can direct parts and/or components to different areas or to other areas of a plant. It will also be understood that the part discharge assembly may comprise a region wherein other robots or material handling structures can automatically pick and place the marked components/parts. The disclosure is not limited to any particular configuration of the part discharge assembly. In still other configurations, the part discharge assembly can be omitted, and the part sorting assembly may comprise an elongated discharge conveyor from where parts can be picked in an automated or manual process.

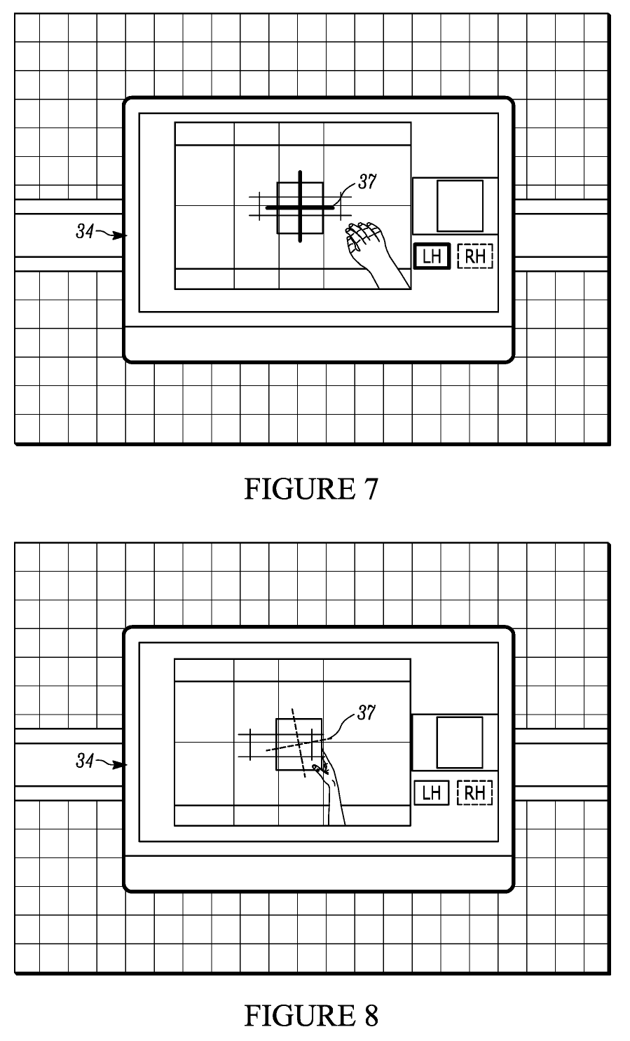

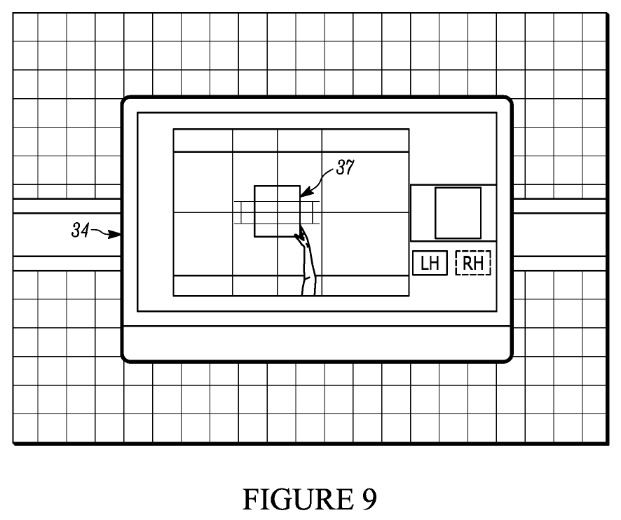

In operation, in the configuration shown, reference is made initially to FIGS. 2 and 4, along with FIGS. 7 through 9. It will be understood that the computing device is programmed such that the configuration of particular parts is known, as well as the correct position of the part on the different conveyors. The system can be set for operation with a single type of part or component or may be utilized in association with a number of different parts or components. The part is initially positioned on the upper surface of the positioning conveyor.

Preferably, while the positioning conveyor is moving and operational, as the user disposes the part onto the upper surface of the positioning conveyor, the user can look at the monitor display 34. An image taken by camera 32 can be shown on the monitor, along with indications as to the proper position of the part on the positioning conveyor. In the configuration shown, a box corresponding to the position of the opening of the part is displayed, along with grid lines. If the part is properly positioned within the box and at the proper angular orientation, a green crosshair extends through the part. Such a configuration is shown in FIG. 7.

On the other hand, if the part is properly situated within the box (and does not generally need to be translated), but is angularly improperly disposed, a yellow crosshair extends through the part, which is rotated from being vertical and horizontal, respectively. This provides a visual indication to the user that it is necessary to rotate the part so that the cross hairs are vertical and horizontal. This configuration, pre rotation is shown in FIG. 8. It will be understood that the crosshairs can change to green once the part has been properly angularly positioned. It will be understood that different parts may have different rotational and positional tolerances, which can be specified by part number or by part type, or by part size either manually by the user, or automatically by the system.

In the event that the part is angularly improperly rotated, and not deemed insufficiently close to being properly positioned, or positioned outside of the box (i.e., the part also needs to be translated), the box turns a red color and the cross hairs are removed. In other words, there are four different states for the part within the system, and, in turn, visual cues, namely 1. Crosshair is green when part is within tolerance; 2. Crosshair is yellow when part is close to tolerance; 3. Crosshair is red when part is detected by the vision system, but is outside of tolerance; or 4. Crosshair is not present when part is not detected by the vision system.

The foregoing is achieved by the computing device comparing the input of the camera with the known proper position of the part for acceptance into the system. It will be understood that the system may be configured to recognize different parts and their proper orientation, so that the system can be used to apply different information on different parts depending on the part that is positioned on the positioning conveyor. In the figures shown, the system is configured to assist with the proper position of both a right and a left hand suspension component of a vehicle, solely through identification of the part utilizing the camera.

In the configuration shown, the box for proper position in a translative manner is elongated, as the user can make adjustments to the rotational or angular orientation of the part while the part is positioned on the positioning conveyor and translating across the conveyor, and relative to the camera.

In the configuration shown, it will be understood that if the part reaches the far end of the box without being in the proper orientation, the positioning conveyor can be directed to stop, reverse or otherwise execute an operation to generally preclude the activation of the marking structure. In the configuration shown, as the positioning conveyor and the marking conveyor are separate and independent conveyors, stopping of the positioning conveyor or reversing of the same does not affect the motion and movement of the marking conveyor nor the parts thereon.

It will be understood that in certain configurations, the process of proper positioning of parts onto the conveyor for introduction into the part marking assembly can be automated. That is, automated material handling equipment can be utilized to introduce the parts onto the positioning conveyor or onto the marking conveyor. There is no requirement of manual placement and manipulation of the parts prior to introduction into the part marking assembly. As such, the part positioning assembly can be omitted from certain of the commercial configurations.

Once the part is properly introduced into the part marking assembly and on the marking conveyor, the position verification member 44 can verify that the part is, indeed, in the correct position and orientation. As indicated above, this secondary verification, after the positioning assembly can be omitted from certain configurations. Nevertheless, once the position verification member confirms that the position is correct and appropriate, the marking conveyor continues to direct the part toward the second end thereof. In many instances, the position verification member provides the data as to the orientation and position of the part as it enters into the part marking assembly, to, in turn, direct the marking structure appropriately.

As the part is proceeding across the part marking assembly, the marking structure is activated. In particular, the robotic arm moves into the appropriate position so that the laser marking member can mark the part in the appropriate location. Based on the position of the part as determined by either the position verification member, or additional sensors which may be on the marking structure, or based on the position determined by the positioning subassembly, the laser marking member is activated to laser etch the desired information onto the part at the desired location. In some configurations, the precise position may change from part to part, while being in the same general region. In other configurations, the robotic arm can move the laser marking member to the appropriate position and, as such, each part, regardless of position, is marked in the same manner and in the same corresponding location.

It will be understood that as the laser etching is being applied to the part, the part continues to move across the part marking assembly, with the marking structure adjusting in position to continue laser etching while the part is moving. In the configuration shown, the laser head itself remains stationary. There are, in the configuration shown, multiple mirror galvanometers (often termed “galvos”) inside the laser marking head that cause the laser beam to move. Additionally, in the configuration shown, an encoder or other identification, can be mounted to the marking conveyor so that the position of the marking conveyor (and, in turn, the position of the part on the conveyor) is known and supplied to the marking structure so that proper actuation of the laser etching can be achieved. As such, parts can keep entering into the part marking assembly, and the laser etching does not have to happen at exactly the same location on the conveyor; rather, the laser etching can start and end at different points along the marking conveyor. In the configuration shown, the laser etching does occur on the same location within the conveyor, along the direction of part travel, although the parts may be positioned at arbitrary positions on the conveyor. Indeed, among other advantages is that the laser etching process is dynamic and the parts do not have to come in at specific intervals. As the side to side (i.e., perpendicular to travel) position is determined when the part enters into the marking assembly and prior to laser etching, and as the marking structure has flexibility and is movable, the marking assembly can be positioned in the correct location regardless of part location on the conveyor. And, multiple parts can be on the marking conveyor at the same time. Of course, without slowing or stopping the marking conveyor there are some limitations. That is, the parts cannot be spaced so close that there is not enough time to move into position to mark the next part after completion of the current mark. It will be understood that one part does not have to exit the marking assembly prior to marking the next part.

It will be understood that if the part enters into the part marking assembly and is somehow in an inappropriate or incorrect position, the marking structure can be directed not to make any markings on the part whatsoever. It is then noted by the system that the part has not been marked. As will be explained, mismarked parts and unmarked parts can be segregated for later or separate handling.

Once the part has traversed through the part marking assembly, and the system confirms that the proper laser etching has been applied to the part, the part is directed onto the part sorting assembly. In the configuration shown, a part that is satisfactory and meets the specifications required during the laser etching process is directed to the upper part discharge location 70 of the part discharge assembly 18. It will be understood that, to achieve discharge onto the pickup 70, the adjustment member of the discharge conveyor must direct the discharge conveyor into the upper position so as to discharge onto the upper part discharge location.

On the other hand, if the part is not marked or mismarked, then it is desirable to segregate such a part. In that case, in the configuration shown, the adjustment member is directed in the downward direction and the second end of the discharge conveyor corresponds to the lower part discharge location. Continued movement of the part along the discharge conveyor will result in the part being directed into the lower part discharge location. The lower part discharge location, in the configuration shown, comprises a locked container, wherein parts can be directed thereinto, but can only be removed when the locked container is opened with keyed access, either physical or software, as required by the end user.

It will be understood that in other configurations, the part sorting assembly may utilize pick and place structures that pick and sort each one of the parts that exit from the part marking assembly. In other configurations, a manual sorting step may be performed by one or more assembly workers in order to manually sort the parts based on different criteria. In still other configurations, multiple conveyor systems may extend from the part marking assembly to account for different types of parts, as well as for satisfactory parts versus rejected parts.

It will be understood that the speed of the different conveyors can be modified automatically or manually depending on a number of factors. If it is found that the throughput into the marking conveyor is too great, the marking conveyor can be slowed down to accommodate the increased flow, or the robotic arm can be increased in size to accommodate a larger range of movement. Furthermore, multiple robotic arms may be positioned within the part marking assembly to accommodate the simultaneous application of part numbers to multiple parts, or to apply multiple laser etchings onto a single part extending through the part marking assembly.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A part marking system comprising:
a part marking assembly having
a marking conveyor with a first end and a second end;
a position verification member associated with the marking conveyor, the position verification member structurally configured to determine the position of a part on the marking conveyor; and
a marking structure comprising a robotic arm positioned in proximity to the marking conveyor, the robotic arm having a laser marking member at a working end thereof, with the laser marking member structurally configured to laser etch indicia onto a part on the marking conveyor;
wherein the robotic arm is structurally configured to move the laser marking member to the proper orientation based on the position of the part, to, in turn, laser etch indicia onto a part while the part is on the marking conveyor and moving on the marking conveyor between the first end and the second end.

2. The part marking system of claim 1 wherein the position verification member comprises a camera.

3. The part marking system of claim 1 wherein the robotic arm has six degrees of freedom.

4. The part marking system of claim 1 further comprising a part positioning assembly, the part positioning assembly comprising:
a positioning conveyor having a first end and a second end, the second end meeting the first end of the marking conveyor; and
a positioning assembly having a camera and a monitor, the camera directed to the positioning conveyor and the monitor structurally configured to display an image from the camera.

5. The part marking system of claim 4 wherein the positioning conveyor and the marking conveyor operate at different speeds.

6. The part marking system of claim 5 wherein the positioning conveyor and the marking conveyor are substantially coplanar.

7. The part marking system of claim 6 wherein the marking conveyor is sized so as to be capable of having a plurality of parts thereon simultaneously.

8. The part marking system of claim 1 further comprising:
a part sorting assembly comprising a discharge conveyor having a first end and a second end, with the first end meeting the second end of the marking conveyor; and
a part discharge assembly having at least one discharge location.

9. The part marking system of claim 8 wherein the part sorting assembly includes a pivot at the first end thereof, and an adjustment member coupled to the conveyor between the first end and the second end thereof, to, in turn, pivot the second end about the pivot.

10. The part marking system of claim 8 wherein the part discharge assembly has an upper part discharge location and a lower part discharge location, with the second end of the discharge conveyor being pivotable so as to be selectively positionable to correspond to each one of the upper part discharge location and the lower part discharge location.

11. The part marking system of claim 1 further comprising:
a part positioning assembly, the part positioning assembly comprising:
a positioning conveyor having a first end and a second end, the second end meeting the first end of the marking conveyor; and
a positioning assembly having a camera and a monitor, the camera directed to the positioning conveyor and the monitor structurally configured to display an image from the camera; and
a part sorting assembly comprising a discharge conveyor having a first end and a second end, with the first end meeting the second end of the marking conveyor; and
a part discharge assembly having at least one discharge location.

12. A method of marking at least one product, comprising:
providing a part marking assembly, the part marking assembly including:
a marking conveyor with a first end and a second end;
a position verification member associated with the marking conveyor, the position verification member structurally configured to determine the position of a part on the marking conveyor; and
a marking structure comprising a robotic arm positioned in proximity to the marking conveyor, the robotic arm having a laser marking member at a working end thereof;
placing a part on the marking conveyor;
actuating the marking conveyor to move the part on the conveyor toward the second end thereof;
actuating the robotic arm to position the laser marking member in a desired orientation to laser etch onto the part;
activating laser marking member to laser etch onto the part while the marking conveyor is actuated.

13. The method of claim 12 wherein the laser marking member is moving throughout the step of activating.

14. The method of claim 12 further comprising the steps of:
positioning the part on a positioning conveyor; and
transferring the part from a positioning conveyor to the marking conveyor.

15. The method of claim 14 wherein the step of positioning the part on a positioning conveyor further comprises the steps of:
placing the part on the positioning conveyor;
viewing a monitor coupled to a camera viewing the part, the monitor providing an indication as to the proper placement of the part on the positioning conveyor;
selectively adjusting the position of the part in response to viewing the monitor and determining that the part is not in the proper placement;
confirming that the part is in the proper placement; and
releasing the part after confirming that the part is in the proper placement.

16. The method of claim 15 wherein the monitor further provides an indication as to how to move the part in the event that the part is not in the proper placement.

17. The method of claim 15 wherein the positioning conveyor is moving during the steps of viewing, selectively adjusting, confirming and releasing.

18. The method of claim 17 wherein the positioning conveyor is moving during the step of placing.

19. The method of claim 15 further comprising the steps of:
discharging the part from the marking conveyor; and
receiving the part onto a discharge conveyor.

20. The method of claim 12 wherein the laser marking member remains stationary during the step of activating the laser marking member while the laser is etching.
